(19) United States
(12) Patent Application Publication
(10) Pub. No.: US 2006/0109217 A1
(43) Pub. Date: May 25, 2006

(54) Emissive circuit capable of adaptively adjusting brightness

(75) Inventors: Shuo-Hsiu Hu, Tainan City (TW); Chih-Feng Sung, Miao-Li City (TW)

Correspondence Address: GENUS LAW GROUP;LOWE HAUPTMAN & BERNER, LLP, 1700 DIAGONAL ROAD, SUITE 300, ALEXANDRIA, VA, 22314, US

(73) Assignee: AU OPTRONICS CORPORATION, Hsinchu (TW)

(21) Appl. No.: 11/040,031

(22) Filed: Jan. 24, 2005

(30) Foreign Application Priority Data
Nov. 19, 2004 (TW) 093135585

(51) Int. Cl. G09G 3/30

(52) U.S. Cl. 345/77

(57) ABSTRACT

An emissive circuit capable of adaptively adjusting brightness is as follows. A brightness adjusting circuit is for receiving the incident ray and is adapted to adjust the power of the driving device according to the intensity of the incident ray. Thus, the driving device, for driving and controlling the brightness of the emissive device according to the intensity of the incident ray, and automatically adjusted itself for having proper brightness and contrast.

### BACKGROUND OF THE INVENTION

1. Field of the Invention

The present invention generally relates to emissive circuit capable of adaptively adjusting brightness, and more particularly to organic light emitting diode capable of adaptively adjusting brightness.

2. Description of the Prior Art

Since the emissive display has advantages such as a thin design, high color saturation, self-emission, fast display and power saving etc., it has been regarded as one of the next generation flat-display techniques for replacing liquid crystal displays (LCDs). Organic electroluminescence displays (OELDs) are one of the emissive techniques; sometimes it is also called organic light emitting diodes (OLEDs). This technique not only has similar advantages of liquid crystal displays (LCDs) but it also has similar advantages of the light emitting diodes (LEDs).

FIG. 1 shows a schematic diagram illustrating a traditional circuit for a pixel unit of an OLED. In a pixel unit 100, the gate G of the P type thin-film transistor (P-TFT) 101 inputs the data signal Vdata, and the P-TFT forms gate-source potential |Vgs| to control the Id current for driving the OLED 102 for emitting light.

According to previous OLED specifications, the OLED has self-emission characteristics. The contrast of the emissive display is worse than the contrast of the reflective display when the incident ray is strong. In other words, when the incident ray is stronger than the brightness of the display, the user cannot clearly recognize the text in the display. Or when the incident ray is smaller than the brightness of the display, the user will easily feel the light is harsh. As the result, how to follow the incident ray to adjust the brightness of the display becomes an important subject of the OLED to solve.

In order to solve the above-mentioned problems, there is the one who uses an external liquid crystal cell detector for measuring incident rays in a LCD system. And then using feedback signal controls the driving potential of the display pixel further achieves the adjustment of brightness in the display. Such as U.S. Pat. No. 5,153,756, disclosed. Furthermore, there is another one who uses an inorganic photo-detector unit for detecting the incident ray and according to the variation of the incident ray, the system auto-adjusting brightness of the emissive display. Such as R.O.C patent, 567353, disclosed. Although the prior art provides a technique to create a feedback system, but it imperceptibly increases the complexity for making and designing and further increases the cost for production. Furthermore, the prior arts in application are limited in making the detecting point within a certain size. Accordingly there is a need to provide a system that is not only following the incident ray to adjust the brightness of the display but also solving the problems of prior art.

### SUMMARY OF THE INVENTION

In view of the above described, an object of the present invention to provide a system for adjusting the brightness. The system according to the intensity of the incident ray automatically adjusts the power of the pixel unit for adjusting the brightness and the contrast of the display.

It is a further object of the present invention to provide a system for adjusting brightness. The system according to the intensity of the incident ray automatically adjusts the difference potential of the two ends of the adjusting circuit for adjusting the brightness and the contrast of the display.

According to the previously said object, the present invention provides an emissive circuit capable of adaptively adjusting brightness and one of characteristics is providing a brightness adjusting circuit. In one embodiment, when the intensity of the incident ray rises, the brightness adjusting circuit follows and increases the current of the emissive device. Therefore, the emissive intensity of the emissive device becomes stronger for keeping the contrast of the display. Otherwise, when the intensity of the incident ray is reduced, the brightness adjusting circuit reduces the current of the emissive device for avoiding harsh light.

### BRIEF DESCRIPTION OF THE DRAWINGS

FIG. 1 shows a schematic diagram illustrating a traditional circuit for a pixel unit of an organic electroluminescence display;

FIG. 2 shows a schematic diagram illustrating a circuit for a pixel unit of display of one embodiment of the present invention;

FIG. 3 shows a schematic diagram illustrating another circuit for a pixel unit of display of other embodiment of the present invention; and

FIG. 4 shows a schematic diagram illustrating an emissive circuit and a brightness adjusting circuit according to the present invention.

### DESCRIPTION OF THE PREFERRED EMBODIMENTS

The present invention provides an emissive circuit capable of adaptively adjusting the brightness. Some of the embodiments of the present invention will be described in detail and clearly as follows. Otherwise, for easily understanding and clarifying the invention, the parts of the illustration is not depicted in corresponding scale. Some scales and related ratio has been exaggerated, and the unrelated parts have not fully shown for the concise drawing. However, except for the detailed description, the invention can widely apply in others. And the invention is not limited here but the claims.

Referring to FIG. 2, it shows a schematic diagram illustrating a circuit for a pixel unit of display of one embodiment of the present invention. In order to clarify the present invention, only one pixel unit is depicted here. However, the technician who is familiar in the field knows how to combine all the pixel units to form a dots array display. Furthermore, the emissive device can be adapted to the invention although the embodiments take examples as an organic light emitting diode (OLED), however, the other emissive device can to applicable the present invention.

The pixel unit normally combines the emissive device 202 and the driving circuit 201 is electrically connected in series. In the present embodiment, the emissive device 202 is an organic light emitting diode (OLED); the driving circuit 201 includes a P type thin film transistor (P-TFT) and it can further be a low temperature poly-silicon (LTPS), the amorphous silicon (a-Si) or the organic thin film transistor. The pixel unit (201, 202) and the brightness adjusting circuit 203 are electrically connected in series and they are normally using the same procedures to be formed on the glass substrate. The brightness adjusting circuit 203 is basically an optical sensor or optical detecting device or circuit. For example, it can be a device of the photo-reactive resistance (or say light-resistance) or it can be an apparatus that generates leakage current when receiving light.

The cathode of the OLED 202 is electrically connected to the power end Vss and the anode is electrically connected to the drain, D of the P-TFT. The two ends of the brightness adjusting circuit 203 are connected to the other power end Vdd and the source, S of the P-TFT, respectively and between the two ends, there is a potential difference. The potential difference depending on the changing of the intensity of the incident ray adjusts the potential of the source, S of the P-TFT. The data signal Vdata transmitting to the gate, G of the P-TFT and the potential difference of the source, S of the P-TFT control the emissive intensity of the emissive device 202. The brightness adjusting circuit 203 is for receiving the incident ray from the ambient environment and according to the intensity of the incident ray it changes the characteristics (such as adjusted the resistance value or adjusted the two ends potential difference) for adjusting the potential or current of the pixel unit 201, 202. For instance, when the intensity of incident ray increases, the brightness adjusting circuit 203 reduces its resistance or reduces its two ends potential. In the present embodiment, when the potential difference of the two ends of the brightness adjusting circuit 203 reduces, and the inputting data Vdata of the driving circuit 201 are not changed, so the source S and the gate G of the potential difference of the P-TFT increase so as to immediately increase the driving current Id of the emissive device 202, then the emissive intensity of the emissive device 202 increases and the brightness and the contrast of the display are kept. On the contrary, when the intensity of the incident ray decreases, the brightness adjusting circuit 203 adjusts the driving current Id for avoiding harsh lightening.

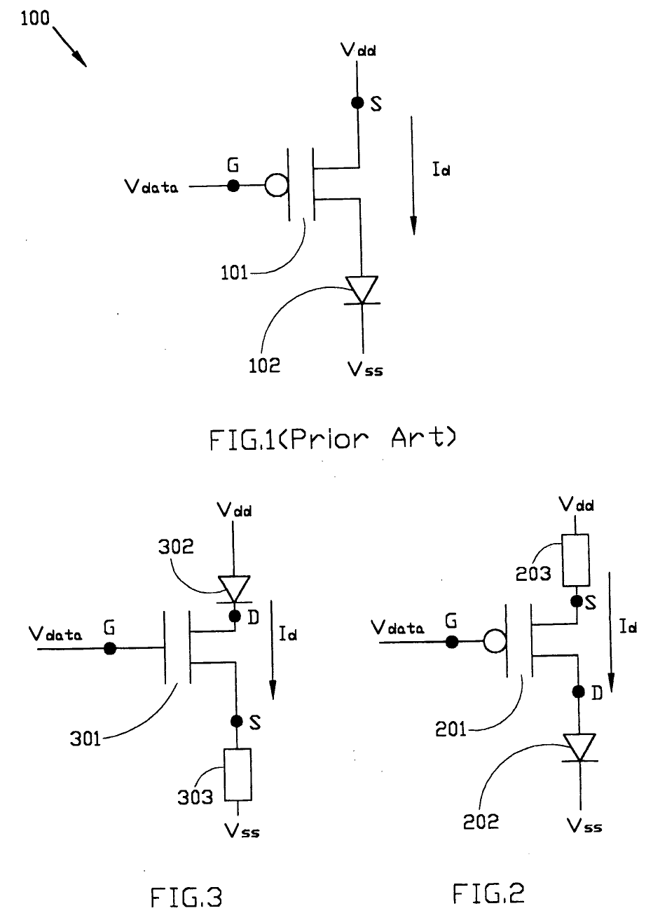

Referring to FIG. 3, it shows a schematic diagram illustrating another circuit for a pixel unit of the display of another embodiment of the present invention. Similarly, in order to clarify the present invention, only one pixel unit is depicted here. In the present embodiment, the pixel unit is combined with OLED 302 and N type thin film transistor (N-TFT) 301 are electrically connected in series.

The anode of the OLED 302 is electrically connected to the power end Vdd and the cathode is electrically connected to the drain D of the N-TFT 301. The two ends of the brightness adjusting circuit 303 are electrically connected to the other power end Vss and the source S of the N-TFT 301, respectively. The inputting data Vdata are received from the gate G of the N-TFT 301 and it uses to control the emissive intensity of the emissive device 302. The brightness adjusting circuit 303 receives incident ray from the ambient environment and according to the intensity of the incident ray it changes its characteristic (such as adjusted the resistance value or adjusted the two ends potential difference) for adjusting the outputting potential of the brightness adjusting circuit 303, the potential of the pixel unit 301, 302 or the value of the Id current. The theory of the circuit operation is similar to FIG. 2 and it is not going to repeat the description.

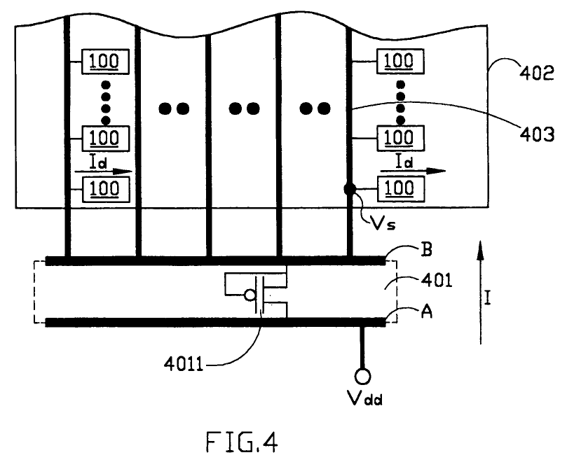

FIG. 4 shows a schematic diagram illustrating an emissive circuit and a brightness adjusting circuit according to the further embodiment of the present invention. Referring to FIG. 4, it helps to further understand the internal operation of the brightness adjusting circuit (including 203 or 303) and to understand the relation between the brightness adjusting circuit and other pixel units. The display area 402 includes the pixel unit 100 arranged in dot a array. Every sequential pixel unit is electrically connected to the power line 403, respectively. And then every power line 403 is collected to be a power bus B. The other power bus A is electrically connected to the power end Vdd. In the present embodiment, the brightness adjusting circuit 401 includes one or more P-TFT 4011. However, the brightness adjusting circuit 401 also can use N-TFT or other optical sensor or optical detector.

When the display operation, the potential Vs between the power bus B and power line 403 is:
Vs=Vdd−I*(RA+R401+RB)
Wherein, the “I” means that the current goes through the power bus A, the brightness adjusting circuit 401 and the power bus B. The “RA” means the resistance of the power bus A. The “RB” means the resistance of the power bus B. And the “R401” means the resistance of the brightness adjusting circuit 401.

The gate-source potential Vgs of the driving TFT (such as P-TFT in FIG. 2) in the pixel unit is:
Vgs=Vdata−(Vdd−I*(RA+R401+RB))
According to the equation, when the intensity of the incident ray is increased it brings about the resistance R401 of the brightness adjusting circuit 401 decreased or the potential difference of the two ends of the brightness adjusting circuit 401 reduced, the Vgs of the P-TFT of the pixel unit 100 goes more negative. In other words, the absolute value of gate-source potential |Vgs| of the P-TFT goes larger (such as |Vgs| become big) so as to increase the Id current, which goes through emissive device (such as emissive device 202 shown in FIG. 2) to emit more strongly. It means that the intensity of the incident ray is substantially in direct proportion to the current, which goes through OLED. Another embodiment, since the intensity of the incident ray decreases, the resistance R401 of the brightness adjusting circuit 401 increases. When the resistance R401 of the brightness adjusting circuit 401 increases, the current Id which goes through the OLED decreases to emit more light. As the result, the invention achieves the purpose of auto-adjusting brightness.

Although the description discloses the preferred embodiment herein, it is not limit the spirit of the invention. It is intended that the specification and examples to be considered as exemplary only, with a true scope and spirit of the invention being indicated by the following claims. For instance, in the embodiment of the present invention, the power line 403 and the power bus B can be suitably and selectively layout. The brightness adjusting circuit 401 is required depending on the actual condition to increase or decrease. The layout and the amount of the brightness adjusting circuit 401 also can be adjusted. For example: the brightness adjusting circuit 401 can be placed on the bottom of the display and be formed as a bar. When the shadow partially blocks the brightness adjusting circuit the display changes a little light and it does not affect viewing. When the ambient environment is not any light, the brightness adjusting circuit 401 adaptively adjusts to the minimum brightness and the user will not feel as harsh.

What is claimed is:

1. An emissive circuit capable of adaptively adjusting brightness having an emissive device and a data line, comprising:
a power end;
a brightness adjusting circuit, electrically connected to said power end, having a first potential end and a second potential end, said brightness adjusting circuit receiving the intensity of incident ray for generating a potential difference between said first potential end and said second potential end, and adjusting the current passing through said emissive device according to said potential difference; and
a driving device, electrically connected to said brightness adjusting circuit and said emissive device, respectively, for driving said emissive device according to the potential of said data line.

2. The emissive circuit according to claim 1, wherein said emissive device comprises an organic light emitting diode (OLED).

3. The emissive circuit according to claim 1, wherein said driving device comprises a P type thin-film-transistor (P-TFT) or an N type thin-film-transistor (N-TFT).

4. The emissive circuit according to claim 1, wherein said brightness adjusting circuit, said emissive device and said driving device are electrically connected in series.

5. The emissive circuit according to claim 4, wherein said brightness adjusting circuit is adapted to adjust the current passing through said emissive device according to the intensity of said incident ray.

6. The emissive circuit according to claim 5, wherein said current passing through said emissive device is substantially in direct proportion to said intensity of said incident ray.

7. The emissive circuit according to claim 6, wherein said brightness adjusting circuit comprises a thin-film-transistor (TFT) for controlling the brightness of said emissive device.

8. The emissive circuit according to claim 4, wherein said brightness adjusting circuit is adapted to adjust said potential difference between said first potential end and said second potential end according to said intensity of said incident ray.

9. The emissive circuit according to claim 4, wherein said brightness adjusting circuit is adapted to adjust the resistance of said brightness adjusting circuit according to said intensity of said incident ray.

10. The emissive circuit according to claim 9, wherein the resistance of said brightness adjusting circuit is substantially in inverse proportion to said intensity of said incident ray.

11. The emissive circuit according to claim 10, wherein said brightness adjusting circuit comprises a light-resistance for controlling the brightness of said emissive device.

12. The emissive circuit according to claim 4, wherein said emissive device, said driving device, and said brightness adjusting circuit are disposed on a glass substrate.

13. A flat-display apparatus having a plurality of pixel units, comprising an emissive circuit of claim 1 for controlling the brightness of each pixel unit.
